(19) United States
(12) Patent Application Publication
(10) Pub. No.: US 2025/0321886 A1
(43) Pub. Date: Oct. 16, 2025

(54) RECONFIGURATION OF EMMC PARTITIONS

(71) Applicant: Micron Technology, Inc., Boise, ID (US)

(72) Inventor: Gianluca Coppola, Liveri (IT)

(21) Appl. No.: 19/175,810

(22) Filed: Apr. 10, 2025

Related U.S. Application Data
(60) Provisional application No. 63/633,561, filed on Apr. 12, 2024.

(51) Int. Cl. G06F 12/02

(52) U.S. Cl. CPC G06F 12/0246; G06F 2212/7206

(57) ABSTRACT

Devices and techniques that provide reconfigurable eMMC partitions are described herein. A flash memory device includes a register to store card specific data including a reconfiguration lock flag indicating whether partitions on the flash memory device are reconfigurable. The flash memory device can include an interface controller and a memory device able to be configured into one or more partitions by the interface controller.

### PRIORITY APPLICATION

This application claims the benefit of priority to U.S. Provisional Application Ser. No. 63/633,561, filed Apr. 12, 2024, which is incorporated herein by reference in its entirety.

### BACKGROUND

Memory devices are typically provided as internal, semiconductor, integrated circuits in computers or other electronic devices. There are many diverse types of memory including volatile and non-volatile memory. Volatile memory can require power to maintain data and includes random-access memory (RAM), dynamic random-access memory (DRAM), and synchronous dynamic random-access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random-access memory (RRAM), and magnetoresistive random access memory (MRAM), 3D XPoint™ memory, among others.

Memory cells are typically arranged in a matrix or an array. Multiple matrices or arrays can be combined into a memory device, and multiple devices can be combined to form a storage volume of a memory system, such as a solid-state drive (SSD), a Universal Flash Storage (UFS™) device, a MultiMediaCard (MMC) solid-state storage device, an embedded MMC device (eMMC™), etc., as discussed further below.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

To easily identify the discussion of any particular element or act, the most significant digit or digits in a reference number refer to the figure number in which that element is first introduced.

FIG. 1 and FIG. 2 illustrate an organization of an embedded MultiMediaCard (eMMC) address space, before and after partitioning, according to embodiments.

FIG. 3 is a block diagram illustrating an architecture, according to an embodiment.

FIG. 4 is a flowchart illustrating an example method for using a reconfiguration lock field in an eMMC, in accordance with some embodiments.

FIG. 5 illustrates a block diagram of an example machine with which, in which, or by which any one or more of the techniques (e.g., methodologies) discussed herein can be implemented.

### DETAILED DESCRIPTION

Aspects of the present disclosure are directed to reconfiguration of embedded MultiMediaCard (eMMC) devices. MultiMediaCard (MMC) standards specifications include features for partitioning logical address space in a managed memory device. Partitioning the logical addressable space permits the controlling software layers to segment the available memory space to store different types of data or code. The systems and techniques described herein are used to provide reconfiguration of an eMMC's address space. Additional details are set forth below.

Memory devices can include arrays of memory cells. Managed memory devices can include a memory control unit to control or manage access to the memory arrays according to multiple memory management protocols. Memory devices include individual memory die, which may, for example, include a storage region comprising one or more arrays of memory cells, implementing one (or more) selected storage technologies. Such memory die will often include support circuitry for operating the memory array(s). Other examples, sometimes known as “managed memory devices,” include assemblies of one or more memory die associated with controller functionality configured to control operation of the one or more memory die. Such controller functionality can simplify interoperability with an external device, such as a “host” device as discussed later herein. In such managed memory devices, the controller functionality may be implemented on one or more die also incorporating a memory array, or on a separate die. In other examples, one or more memory devices may be combined with controller functionality to form a solid state drive (SSD) storage volume.

Embodiments of the present disclosure are described in the example of managed memory devices implementing NAND flash memory cells. These examples can be referred to as managed NAND or mNAND devices. These examples, however, are not limiting on the scope of the disclosure, which may be implemented in other forms of memory devices and/or with other forms of storage technology.

NOR and NAND flash architecture semiconductor memory arrays are accessed through decoders that activate specific memory cells by selecting the word line coupled to their gates. In a NOR architecture semiconductor memory array, once activated, the selected memory cells place their data values on bit lines, causing different currents to flow depending on the state at which a particular cell is programmed. In a NAND architecture semiconductor memory array, a high bias voltage is applied to a drain-side select gate (SGD) line. Word lines coupled to the gates of the unselected memory cells of each group are driven at a specified pass voltage (e.g., Vpass) to operate the unselected memory cells of each group as pass transistors (e.g., to pass current in a manner unrestricted by their stored data values). Current then flows from the source line to the bit line through each series coupled group, restricted only by the selected memory cells of each group, placing current encoded data values of selected memory cells on the bit lines.

Each flash memory cell in a NOR or NAND architecture semiconductor memory array can be programmed individually or collectively to one or a number of programmed states. For example, a single-level cell (SLC) can represent one of two programmed states (e.g., 1 or 0), representing one bit of data. Flash memory cells can represent more than two programmed states, allowing the manufacture of higher density memories without increasing the number of memory cells, as each cell can represent more than one binary digit (e.g., more than one bit). Such cells can be referred to as multi-state memory cells, multi-digit cells, or multi-level cells (MLCs). In certain examples, MLC can refer to a memory cell that can store two bits of data per cell (e.g., one of four programmed states), a triple-level cell (TLC) can refer to a memory cell that can store three bits of data per cell (e.g., one of eight programmed states), and a quad-level cell (QLC) can store four bits of data per cell. MLC is used herein in its broader context, to refer to any memory cell(s) that can store more than one bit of data per cell (i.e., that can represent more than two programmed states).

Managed memory devices may be configured and operated in accordance with recognized industry standards. For example, managed NAND devices may be (as non-limiting examples), a Universal Flash Storage (UFS™) device, or an embedded MMC device (eMMC™), etc. For example, UFS devices may be configured in accordance with Joint Electron Device Engineering Council (JEDEC) standards (e.g., JEDEC standard JESD223D, entitled “JEDEC UFS Flash Storage 3.0,” and/or previous versions, updates, or subsequent versions to such standard). Similarly, identified eMMC devices may be configured in accordance with JEDEC standard JESD84-A51, entitled “JEDEC eMMC standard 5.1”, and/or previous versions, updates, or subsequent versions to such standard.

Managed memory devices can include a number of memory devices, including a number of dies or logical units (e.g., logical unit numbers or LUNs), and can include one or more processors or other controllers performing logic functions required to operate the memory devices or interface with external systems. Such managed memory devices can include one or more flash memory die, including memory arrays and peripheral circuitry thereon. The flash memory arrays can include blocks of memory cells organized into physical pages. Managed NAND devices can include one or more arrays of volatile and/or nonvolatile memory separate from the NAND storage array, and either within or separate from a controller. Both SSDs and managed NAND devices can receive commands from a host in association with memory operations, such as read or write operations to transfer data (e.g., user data and associated integrity data, such as error data and address data, etc.) between the memory devices and the host, or erase operations to erase data from the memory devices.

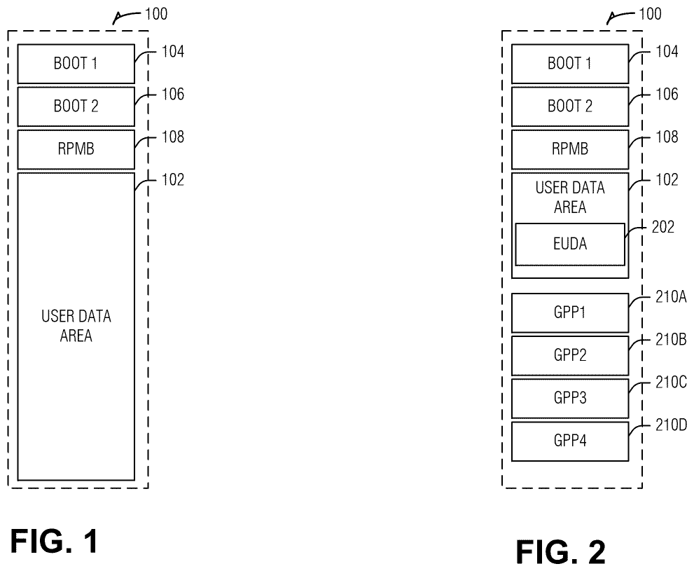

FIG. 1 and FIG. 2 illustrate an organization of an embedded MultiMediaCard (eMMC) address space, before and after partitioning, according to embodiments. By default, the address space of the eMMC device 100 includes a User Data Area (UDA) 102, two possible boot area partitions (e.g., Boot1 104 and Boot2 106), and a Replay Protected Memory Block (RPMB) partition 108. The boot and the RPMB partition sizes and attributes can be defined by a memory vendor.

The eMMC device 100 allows the host to configure partitions, such as shown in the example of FIG. 2. For example, the host can configure four General Purpose Partitions (GPP) (e.g., GPP1 210A, GPP2 210B, GPP3 210C, and GPP4 210D) and an Enhanced User Data Area (EUDA) 202. Each of the four General Purpose Partitions has a respective independent address space, starting from logical address 0x00000000. The GPPs can be configured for different usage models. Each of the four GPPs may be configured as enhanced (e.g., SLC). One segment in the UDA 102 may be configured as enhanced (e.g., SLC).

As part of a device configuration routine, the host may set the starting location and size of the GPPs 210A-D and the EUDA 202. In conventional eMMC devices, the size and attributes of the EUDA 202 and GPPs 210A-D can only be programmed once during the lifetime of the eMMC device 100. This is a severe limitation during system development when a user wants to test different combinations of partitions and configurations. In the embodiments discussed here, however, the eMMC device 100 is reconfigurable.

In an example, the eMMC v4.4 specification defines a 512-byte Extended CSD (card specific data) register that contains eMMC parameters. The most significant 320 bytes are the Properties segment, which defines the card's capabilities and cannot usually be modified by the host. The lower 192 bytes are the Modes segment, which defines the configuration the card is working in. These modes can be changed by the host by means of the SWITCH command (also referred to as CMD6 in JEDEC documentation).

There are several reserved areas in the Properties segment. In the embodiments described herein, one of the reserved fields in the Extended CSD data structure is used as a flag to lock the configuration. This field is referred to as a reconfiguration lock field (RECONFIG_LOCK). The reconfiguration lock field is set to ‘0’ by default. A host may write to the reconfiguration lock field to lock the current card configuration. Until the reconfiguration lock field is written to (e.g., write a ‘1’ to the field), the host is allowed to reconfigure the eMMC device 100 one or more times.

After setting the reconfiguration lock field to ‘1’, the eMMC device 100 will not allow the host to reconfigure partitions any further. Any command to reconfigure partitions will result in an error response.

As such, in various examples, the reconfiguration lock field may be set to 0, in which case, the eMMC firmware (FW) will accept commands to reconfigure eMMC partitions, one or more times. Partitions may include GPPs, Enhanced User Data Area, or vendor partitions as Ultra-Endurance Partitions. The attributes and size of the partitions may also be changed accordingly. The eMMC specification defines methods to define the initial size and attributes of each partition. The same or similar method may be used to reconfigure the partitions when the reconfiguration lock field is set to ‘0’. The reconfiguration ability is useful during host software development. Reconfiguration may include a mix of SLC and TLC blocks. For instance, a block configured as TLC in one configuration may be reconfigured as SLC in another configuration. A memory device vendor may define a maximum number of times that a device, such as the eMMC device 100, may be reconfigured.

An example definition of a 1-byte RECONFIG_LOCK field in the Extended CSD is provided here.

RECONFIG_LOCK field. This register is used by the host to determine whether the device is allowed to reconfigure partitions. It is set to ‘0’ by default and can be set to ‘1’ by a SWITCH command.
Bit[7:1]: Reserved
Bit 0: ENABLE
0x0: Boot, RPMB, and User Data Area partitions are reconfigurable. (default)
0x1: Boot, RPMB, and User Data Area partition properties are locked and cannot be reconfigured.

It is understood that reserved bits [7:1] may be used to define other properties, such as the maximum number of times a device has been reconfigured, a total number of times a device has been configured, and the like.

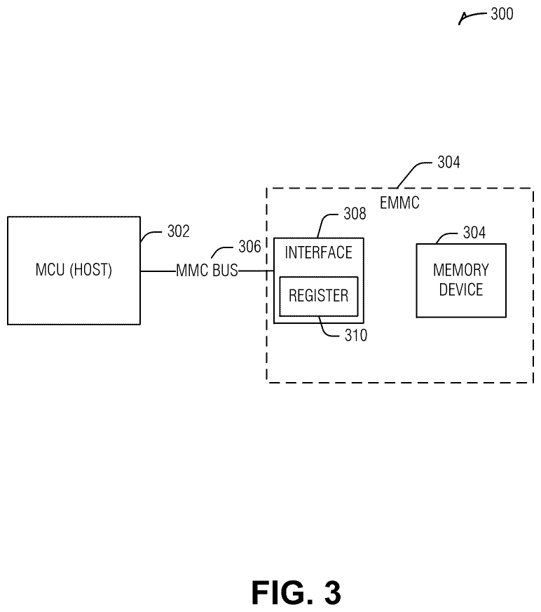

FIG. 3 is a block diagram illustrating an architecture 300, according to an embodiment. The architecture 300 includes an external Memory Controller Unit (MCU) 302 interconnected to a nonvolatile managed memory 304 though an MMC Bus 306. The nonvolatile managed memory 304 includes an eMMC interface 308, an Extended CSD Register 310, and a memory device 312. Memory device 312 may be of various types including Phase-Change Memory (PCM), Multi-level Cell NAND Flash, or other similar technologies or combinations of memory device technologies. The MMC Bus 306 uses a clock signal (CLK) that synchronizes bus transfers, a command signal (CMD) that send commands to the device from the host over a bidirectional command channel and receives responses from the device at the host, and bidirectional data signals (DAT [7:0]). The data signals may be configured for single bit, 4-bit, or 8-bit data transfer.

The eMMC interface 308, or interface controller, manages commands and responses received over the MMC Bus 306 from the host (MCU 302). The commands from the host are visible to the eMMC interface 308. The eMMC interface 308 manage transactions for the partitions on the nonvolatile managed memory 304, i.e., boot, RPMB, GPPs, EUDA, etc. Partition parameters are stored in an Extended CSD Register 310.

The MCU 302 uses the MMC Bus 306 to configure the nonvolatile managed memory 304 by setting values in the Extended CSD Register 310 via the eMMC interface 308. Partitions and partition parameters may be created or modified by configuring fields in the Extended CSD Register 308. A host may initiate the SWICH command from the MCU 302 to modify fields in the Extended CSD Register 308 to configure partitions.

When the MCU 302 transmits a command that affects one or more partitions on the nonvolatile managed memory 304, the eMMC interface 308 first checks the designated RECONFIG_LOCK field in the Extended CSD Register 310. If the RECONFIG_LOCK field is ‘0’, then the eMMC interface 308 may allow various operations that affect partitions on the nonvolatile managed memory 304. If the RECONFIG_LOCK field is ‘1’, then the eMMC interface 308 may return an error to the MCU 302.

After the MCU 302 is used to configure and then possibly reconfigure the nonvolatile managed memory 304 to the user's satisfaction, a SWITCH command may be issued to set the RECONFIG_LOCK field to ‘1’. This sets the nonvolatile managed memory 304 in a non-reconfigurable mode where further partition reconfiguration is not possible. In an example, this is a one way operation and the RECONFIG_LOCK field cannot be set back to ‘0’.

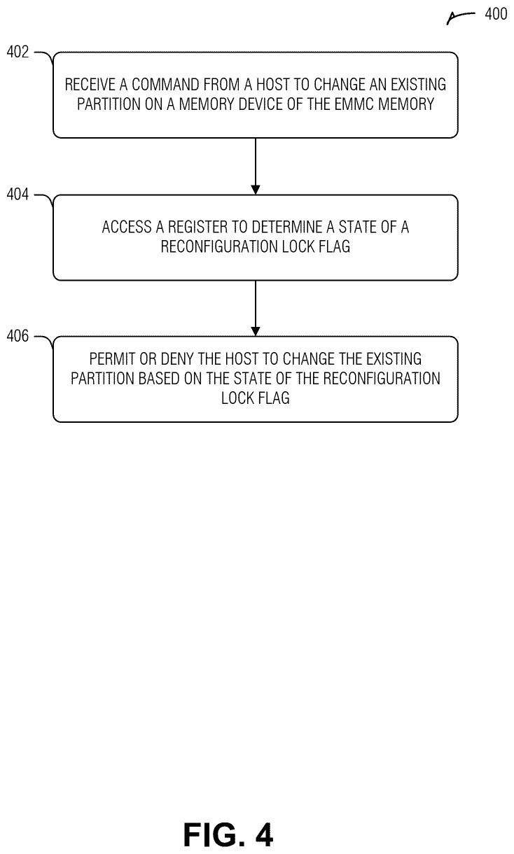

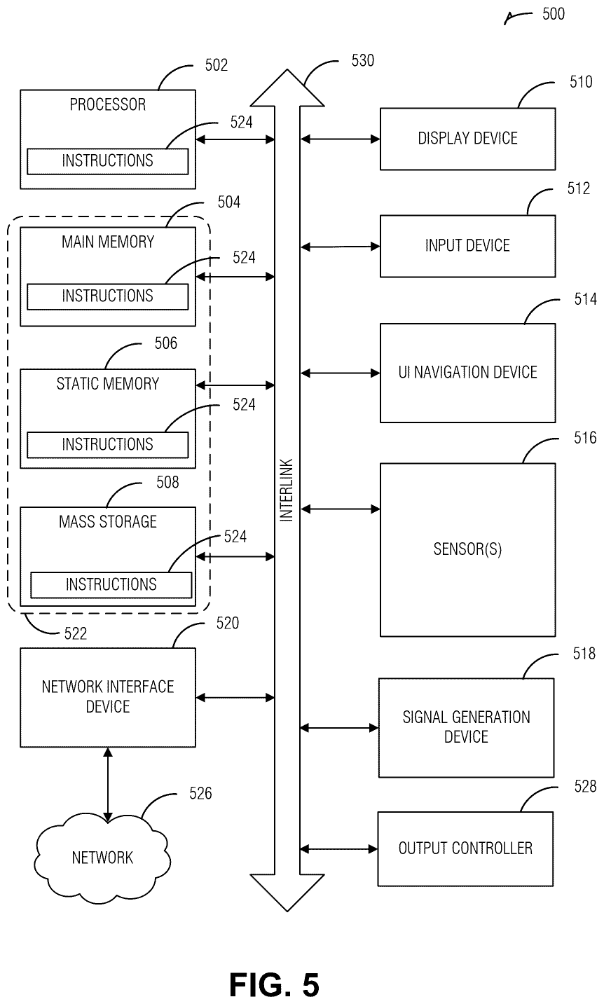

FIG. 4 is a flowchart illustrating an example method 400 for controlling reconfiguration of a flash memory device (e.g., an eMMC memory), in accordance with some embodiments. The method 400 can be performed by processing logic that can include hardware (e.g., processing device, circuitry, dedicated logic, programmable logic, microcode, hardware of a device, integrated circuit, etc.). In some embodiments, the method 400 is performed by the MCU 302 or eMMC interface 308 of FIG. 3, or the hardware processor 502 of FIG. 5.

At operation 402, the method 400 includes the operation of receiving, at an interface controller of the flash memory device, a command from a host to change an existing partition on a memory device of the flash memory device.

At operation 404, the method 400 includes the operation of accessing a register to determine a state of a reconfiguration lock flag. In an embodiment, the reconfiguration lock flag is stored in an Extended Card Specific Data register of the flash memory device. As such, in an embodiment, accessing the register comprises accessing an Extended Card Specific Data register.

In an embodiment, the reconfiguration lock flag is initially unset. For example, the reconfiguration lock flag may be provided from a device vendor to customers with the reconfiguration lock flag unset, thereby permitting the customers to reconfigure the flash memory device one or more times before locking the configuration. In an embodiment, the reconfiguration lock flag is one-way settable. Thus, for example, after a customer has reconfigured the flash memory device to a satisfactory state, the customer can lock the flash memory device so that it is no longer reconfigurable. However, this may be a one-way operation. The method 400 may include allowing the reconfiguration lock flag to be changed from an unset state to a set state and then disallowing the reconfiguration lock flag to be changed from the set state.

At operation 406, the method 400 includes the operation of permitting or denying the host to change the existing partition based on the state of the reconfiguration lock flag.

Although shown in a particular sequence or order, unless otherwise specified, the order of the methods or processes described herein can be modified. Thus, the illustrated embodiments should be understood only as examples, and the illustrated processes can be performed in a different order, and some processes can be performed in parallel. Additionally, one or more processes can be omitted in various embodiments. Thus, not all processes are used in every embodiment. Other process flows are possible.

FIG. 5 illustrates a block diagram of an example machine 500 with which, in which, or by which any one or more of the techniques (e.g., methodologies) discussed herein can be implemented. Examples, as described herein, can include, or can operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 500.

In alternative embodiments, the machine 500 can operate as a standalone device or can be connected (e.g., networked) to other machines. In a networked deployment, the machine 500 can operate in the capacity of a server machine, a client machine, or both in server-client network environments. In an example, the machine 500 can act as a peer machine in peer-to-peer (P2P) (or other distributed) network environment. The machine 500 can be a personal computer (PC), a tablet PC, a set-top box (STB), a personal digital assistant (PDA), a mobile telephone, a web appliance, a network router, switch or bridge, embedded memory controller, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 500 (e.g., computer system) can include a hardware processor 502 (e.g., a central processing unit (CPU), a graphics processing unit (GPU), a hardware processor core, or any combination thereof), a main memory 504, a static memory 506 (e.g., memory or storage for firmware, microcode, a basic-input-output (BIOS), unified extensible firmware interface (UEFI), etc.), and mass storage device 508 (e.g., hard drives, tape drives, flash storage, or other block devices) some or all of which can communicate with each other via an interlink 530 (e.g., bus). The machine 500 can further include a display device 510, an alphanumeric input device 512 (e.g., a keyboard), and a user interface (UI) Navigation device 514 (e.g., a mouse). In an example, the display device 510, the input device 512, and the UI navigation device 514 can be a touch screen display. The machine 500 can additionally include a mass storage device 508 (e.g., a drive unit), a signal generation device 518 (e.g., a speaker), a network interface device 520, and one or more sensor(s) 516, such as a global positioning system (GPS) sensor, compass, accelerometer, or other sensor. The machine 500 can include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the hardware processor 502, the main memory 504, the static memory 506, or the mass storage device 508 can be, or include, a machine-readable media 522 on which is stored one or more sets of data structures or instructions 524 (e.g., software) embodying or used by any one or more of the techniques or functions described herein. The instructions 524 can also reside, completely or at least partially, within any of registers of the hardware processor 502, the main memory 504, the static memory 506, or the mass storage device 508 during execution thereof by the machine 500. In an example, one or any combination of the hardware processor 502, the main memory 504, the static memory 506, or the mass storage device 508 can constitute the machine-readable media 522. While the machine-readable media 522 is illustrated as a single medium, the term “machine-readable medium” can include a single medium or multiple media (e.g., a centralized or distributed database, or associated caches and servers) configured to store the one or more instructions 524.

The term “machine readable medium” can include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks.

In an example, information stored or otherwise provided on the machine-readable media 522 can be representative of the instructions 524, such as instructions 524 themselves or a format from which the instructions 524 can be derived. This format from which the instructions 524 can be derived can include source code, encoded instructions (e.g., in compressed or encrypted form), packaged instructions (e.g., split into multiple packages), or the like. The information representative of the instructions 524 in the machine-readable media 522 can be processed by processing circuitry into the instructions to implement any of the operations discussed herein. For example, deriving the instructions 524 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 can include assembly, compilation, or interpretation of the information (e.g., by the processing circuitry) to create the instructions 524 from some intermediate or preprocessed format provided by the machine-readable media 522. The information, when provided in multiple parts, can be combined, unpacked, and modified to create the instructions 524. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 can be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 can include one or more physical jacks (e.g., Ethernet, coaxial, or phone jacks) or one or more antennas to connect to the network 526. In an example, the network interface device 520 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

To better illustrate the methods and apparatuses described herein, a non-limiting set of Example embodiments are set forth below as numerically identified Examples.

Example 1 is an flash memory device comprising: a register to store card specific data including a reconfiguration lock flag indicating whether partitions on the flash memory device are reconfigurable; an interface controller; and a memory device configurable into one or more partitions by the interface controller when the reconfiguration lock flag indicates the partitions on the flash memory device are reconfigurable.

In Example 2, the subject matter of Example 1 includes, wherein the interface controller manage transactions for up to four General Purpose Partitions.

In Example 3, the subject matter of Examples 1-2 includes, wherein the interface controller manage transactions for two boot areas and a Replay Protected Memory Block (RPMB) partition area.

In Example 4, the subject matter of Examples 1-3 includes, wherein the memory device is a nonvolatile memory device.

In Example 5, the subject matter of Examples 1-4 includes, wherein when the reconfiguration lock flag is not set, the interface controller accepts commands from a host to reconfigure one or more partitions on the memory device.

In Example 6, the subject matter of Examples 1-5 includes, wherein when the reconfiguration lock flag is set, the interface controller rejects commands from a host to reconfigure one or more partitions on the memory device.

In Example 7, the subject matter of Examples 1-6 includes, wherein the register is an Extended Card Specific Data register.

In Example 8, the subject matter of Examples 1-7 includes, wherein the reconfiguration lock flag is initially unset.

In Example 9, the subject matter of Examples 1-8 includes, wherein the reconfiguration lock flag is one-way settable.

Example 10 is a method for controlling reconfiguration of a flash memory device comprising: receiving, at an interface controller of the flash memory device, a command from a host to change an existing partition on a memory device of the flash memory device; accessing a register to determine a state of a reconfiguration lock flag; and permitting or denying the host to change the existing partition based on the state of the reconfiguration lock flag.

In Example 11, the subject matter of Example 10 includes, wherein accessing the register comprises accessing an Extended Card Specific Data register.

In Example 12, the subject matter of Examples 10-11 includes, wherein the reconfiguration lock flag is initially unset.

In Example 13, the subject matter of Examples 10-12 includes, allowing the reconfiguration lock flag to be changed from an unset state to a set state; and disallowing the reconfiguration lock flag to be changed from the set state.

Example 14 is a flash memory device comprising: a register to store card specific data including a reconfiguration lock flag indicating whether partitions on the flash memory device are reconfigurable; an interface controller; and a memory device able to be configured into one or more partitions by the interface controller; wherein the interface controller is configured to: receive a command from a host to change an existing partition on the memory device of the flash memory device; access the register to determine a state of the reconfiguration lock flag; and permit or deny the host to change the existing partition based on the state of the reconfiguration lock flag.

In Example 15, the subject matter of Example 14 includes, wherein the interface controller manage transactions for up to four General Purpose Partitions.

In Example 16, the subject matter of Examples 14-15 includes, wherein the interface controller manage transactions for two boot areas and a Replay Protected Memory Block (RPMB) partition area.

In Example 17, the subject matter of Examples 14-16 includes, wherein the memory device is a nonvolatile memory device.

In Example 18, the subject matter of Examples 14-17 includes, wherein when the reconfiguration lock flag is not set, the interface controller accepts commands from a host to reconfigure one or more partitions on the memory device.

In Example 19, the subject matter of Examples 14-18 includes, wherein when the reconfiguration lock flag is set, the interface controller rejects commands from a host to reconfigure one or more partitions on the memory device.

In Example 20, the subject matter of Examples 14-19 includes, wherein the register is an Extended Card Specific Data register.

In Example 21, the subject matter of Examples 14-20 includes, wherein the reconfiguration lock flag is initially unset.

In Example 22, the subject matter of Examples 14-21 includes, wherein the reconfiguration lock flag is one-way settable.

Example 23 is at least one machine-readable medium including instructions that, when executed by processing circuitry, cause the processing circuitry to perform operations to implement of any of Examples 1-22.

Example 24 is an apparatus comprising means to implement of any of Examples 1-22.

Example 25 is a system to implement of any of Examples 1-22.

Example 26 is a method to implement of any of Examples 1-22.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A flash memory device comprising:
a register to store card specific data including a reconfiguration lock flag indicating whether partitions on the flash memory device are reconfigurable;
an interface controller; and
a memory device configurable into one or more partitions by the interface controller when the reconfiguration lock flag indicates the partitions on the flash memory device are reconfigurable.

2. The flash memory device of claim 1, wherein the interface controller manage transactions for up to four General Purpose Partitions.

3. The flash memory device of claim 1, wherein the interface controller manage transactions for two boot areas and a Replay Protected Memory Block (RPMB) partition area.

4. The flash memory device of claim 1, wherein the memory device is a nonvolatile memory device.

5. The flash memory device of claim 1, wherein when the reconfiguration lock flag is not set, the interface controller accepts commands from a host to reconfigure one or more partitions on the memory device.

6. The flash memory device of claim 1, wherein when the reconfiguration lock flag is set, the interface controller rejects commands from a host to reconfigure one or more partitions on the memory device.

7. The flash memory device of claim 1, wherein the register is an Extended Card Specific Data register.

8. The flash memory device of claim 1, wherein the reconfiguration lock flag is initially unset.

9. The flash memory device of claim 1, wherein the reconfiguration lock flag is one-way settable.

10. A method for controlling reconfiguration of a flash memory device comprising:
receiving, at an interface controller of the flash memory device, a command from a host to change an existing partition on a memory device of the flash memory device;
accessing a register to determine a state of a reconfiguration lock flag; and
permitting or denying the host to change the existing partition based on the state of the reconfiguration lock flag.

11. The method of claim 10, wherein accessing the register comprises accessing an Extended Card Specific Data register.

12. The method of claim 10, wherein the reconfiguration lock flag is initially unset.

13. The method of claim 10, comprising:
allowing the reconfiguration lock flag to be changed from an unset state to a set state; and
disallowing the reconfiguration lock flag to be changed from the set state.

14. A flash memory device comprising:
a register to store card specific data including a reconfiguration lock flag indicating whether partitions on the flash memory device are reconfigurable;
an interface controller; and
a memory device able to be configured into one or more partitions by the interface controller;
wherein the interface controller is configured to:
receive a command from a host to change an existing partition on the memory device of the flash memory device;
access the register to determine a state of the reconfiguration lock flag; and
permit or deny the host to change the existing partition based on the state of the reconfiguration lock flag.

15. The flash memory device of claim 14, wherein the interface controller manage transactions for two boot areas and a Replay Protected Memory Block (RPMB) partition area.

16. The flash memory device of claim 14, wherein the memory device is a nonvolatile memory device.

17. The flash memory device of claim 14, wherein when the reconfiguration lock flag is not set, the interface controller accepts commands from a host to reconfigure one or more partitions on the memory device.

18. The flash memory device of claim 14, wherein when the reconfiguration lock flag is set, the interface controller rejects commands from a host to reconfigure one or more partitions on the memory device.

19. The flash memory device of claim 14, wherein the reconfiguration lock flag is initially unset.

20. The flash memory device of claim 14, wherein the reconfiguration lock flag is one-way settable.
